(19) United States
(12) Patent Application Publication
(10) Pub. No.: US 2017/0108003 A1
(43) Pub. Date: Apr. 20, 2017

(54) DIFFUSER FOR A RADIAL COMPRESSOR

(71) Applicant: ABB TURBO SYSTEMS AG, Baden (CH)

(72) Inventor: Daniel Rusch, Wettingen (CH)

(21) Appl. No.: 15/390,449

(22) Filed: Dec. 23, 2016

Related U.S. Application Data
(63) Continuation of application No. PCT/EP2015/063944, filed on Jun. 22, 2015.

(30) Foreign Application Priority Data
Jun. 24, 2014 (DE) 102014108771.2

(51) Int. Cl. F04D 29/44; F04D 25/04; F02B 33/40; F04D 29/28; F04D 29/66; F02B 37/00; F04D 17/10; F04D 29/056

(52) U.S. Cl. CPC F04D 29/444; F04D 17/10; F04D 25/04; F04D 29/056; F04D 29/284; F04D 29/666; F02B 37/00; F02B 33/40

(57) ABSTRACT

Illustrative embodiments of vaned diffusers of radial compressors and exhaust turbochargers comprising the same are disclosed. In some illustrative embodiments, angular spacings between guide vanes of the diffuser which are arranged adjacent to one another may vary along the circumference, allowing resonant vibration of the compressor to be reduced. In addition, the narrowest cross-sectional area between in guide vanes can be held constant, allowing an increased efficiency and a positive effect on the surge margin.

### CROSS-REFERENCE TO RELATED APPLICATIONS

This application is a continuation of International Application No. PCT/EP2015/063944, filed Jun. 22, 2015, and claims priority to German Application No. 102014108771.2, filed Jun. 24, 2014. The entire disclosures of both of the foregoing applications are hereby incorporated by reference.

### TECHNICAL FIELD

The present disclosure relates to the field of exhaust turbochargers for forced-induction internal combustion engines. More particularly, the present disclosure relates to a vaned diffuser of a radial compressor of such exhaust turbochargers and to an exhaust turbocharger having a radial compressor comprising a diffuser with such blading in the outflow region thereof.

### BACKGROUND

To increase the intake pressure of the engine, single-stage radial compressors with vaned diffusers downstream of the compressor impeller are generally used in modern exhaust turbochargers. In the diffuser, the kinetic energy of the medium to be compressed is converted into static pressure. The compressor impellers comprise a certain number of rotor blades, and the diffusers have guide vanes with prismatic, generally aerodynamic, profiles (wedge or airfoil shape). As viewed in the direction of the compressor axis, the guide vanes have a certain tangential angle at the leading edge (entry angle), a certain tangential angle at the trailing edge (exit angle), and a certain angular spacing in the circumferential direction between each two guide vanes arranged adjacent to one another.

In designing compressor stages, there is always a need to find a compromise between aerodynamic performance, mechanical loading, and noise generation by the compressor. Modern compressor stages with high specific displacements have long, thin rotor blades, the eigenforms of which occur at low frequencies and are easily excited and caused to vibrate. One major source of these excitations is a pressure potential field produced by the guide vanes of the diffuser. By deliberately arranging the diffuser guide vanes in an irregular pattern, resonant vibrations, which could otherwise cause high cycle fatigue (HCF) and mechanical damage in the compressor rotor blades, can be avoided.

EP 2 014 925 A1 (US 2010/0150709 A1) discloses how outflow regions of radial compressors can be optimized by diffusers with irregularly distributed guide vanes. For example, seventeen guide vanes are arranged in two groups, respectively comprising nine and eight guide vanes, each distributed on half a ring segment.

With this irregular arrangement of the guide vanes, different flow channel cross sections between each pair of adjacent guide vane pairs are obtained along the circumference. The narrowest cross-sectional areas between two guide vanes, referred to in the technical jargon as “throat areas,” are not constant in the abovementioned example with seventeen vanes, as viewed over the circumference. Here, the narrowest cross-sectional areas are around 3 to 5 percent smaller in the group with nine guide vanes than in the group with eight guide vanes, owing to the smaller distance between the individual vanes.

This results in a different ratio of the flow channels around the circumference at the compressor impeller exit and at the diffuser entry, and this could negatively affect the efficiency and stability of the compressor stage.

Outflow regions of radial compressors having diffusers with irregularly distributed guide vanes are furthermore disclosed in JP2010-151032 and JP1993-026198.

### SUMMARY

One object of the present disclosure is improving the outflow region of a radial compressor in such a way that the partial flow channels in the vaned diffuser have constant narrowest cross-sectional areas (throat areas) despite an unequally distributed arrangement of the guide vanes over the circumference. According to the present disclosure, the diffuser guide vanes distributed over the circumference have angular positions that differ at least in some cases from one another. Here, a different relative angular position is intended to mean that two guide vanes positioned one above the other due to rotation about the axis have a different angular alignment. The presently disclosed diffuser of a radial compressor increases the efficiency of the compressor stage and has a positive effect on the surge margin. Further objects and advantages will become apparent from the claims.

### BRIEF DESCRIPTION OF THE DRAWINGS

Embodiments of the diffuser, designed in accordance with the present disclosure, of a radial compressor are described below with reference to the figures, of which:

FIG. 1 shows a section along the compressor axis through a radial compressor having a vaned diffuser;

FIG. 2 shows a section perpendicular to the compressor axis through a first embodiment of a diffuser designed in accordance with the present disclosure, having irregularly arranged guide vanes; and

FIG. 3 shows a section perpendicular to the compressor axis through a second embodiment of a diffuser designed in accordance with the present disclosure, having two guide vane groups of different sizes, which are each arranged in a manner distributed over half the diffuser.

### DETAILED DESCRIPTION OF THE DRAWINGS

While the concepts of the present disclosure are susceptible to various modifications and alternative forms, specific embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

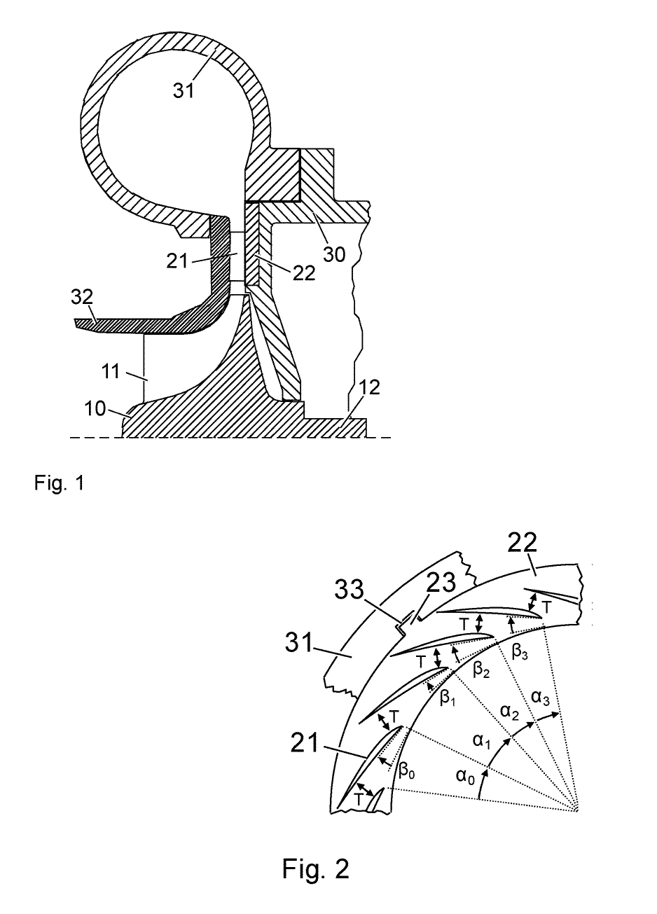

FIG. 1 shows the radial compressor of an exhaust turbocharger in section through the shaft axis. The compressor comprises a compressor impeller, which is arranged on the shaft 12 and comprises a hub 10 and rotor blades 11 arranged thereon. The rotor blades can be divided into main blades and intermediate blades, wherein the main blades extend over the entire length of the flow channel bounded by the hub and the adjoining casing part, while the intermediate blades are generally of shorter design and have a leading edge which is set back. In this case, one or more intermediate blades can be provided for each main blade. The compressor impeller is arranged in the compressor casing, which generally comprises a number of parts, e.g. the spiral casing 31 and the inlet casing 32. Situated between the compressor and the turbine (not shown) is the bearing housing 30, which contains the bearing assembly for the shaft. The already mentioned flow channel in the region of the compressor is bounded by the compressor casing. In the region of the compressor impeller, the hub of the compressor impeller provides the radially inner boundary, wherein the rotor blades of the compressor impeller are arranged in the flow channel. Arranged downstream of the compressor impeller in the flow direction of the medium to be compressed is the diffuser. As mentioned at the outset, the diffuser serves to slow down the flow accelerated by the compressor impeller. This is accomplished, on the one hand, by the guide vanes 21 of the diffuser and, on the other hand, by the spiral casing, from where the compressed medium is fed to the combustion chambers of an internal combustion engine. The guide vanes of the diffuser are connected on one or both sides of the flow channel to a diffuser wall 22, a part of the casing. Together with the diffuser walls, each pair of diffuser guide vanes arranged adjacent to one another delimits a diffuser channel.

In order to prevent high cycle fatigue in the rotor blades of the compressor impeller, as described at the outset, the diffuser has a plurality of guide vanes having angular spacings that differ at least in some cases. Here, the term “angular spacing” refers to the angle between the leading edges of two guide vanes arranged adjacent to one another. Optionally, the term “angular spacing” can also be used to refer to the angle between two other mutually corresponding points of two guide vanes arranged adjacent to one another, for instance, when the leading edges are situated on different radii. In this case, the term “angular spacing” can be used to refer to the angle between the trailing edges or the angle between the profile centers, for instance. Thus, the angular spacings between guide vanes that are arranged adjacent to one another are not identical over the entire circumference. There are several possibilities for implementing diffusers with varying angular spacings between the guide vanes.

In a first embodiment, shown in FIG. 2, the angular spacings αₓ are different for all the pairs of diffuser guide vanes 21 arranged adjacent to one another, i.e. no two of the angular spacings shown between in each case two adjacent guide vanes are identical.

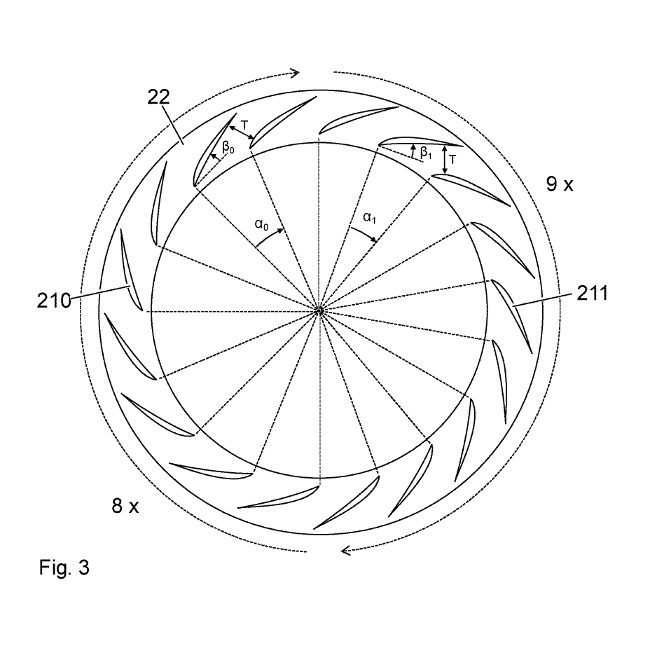

In the example shown, the different angular spacings α₀, α₁, α₂, α₃ are furthermore distributed in an irregular manner. As an alternative, the angular spacings could also increase or decrease in a regular manner in one circumferential direction, or could first increase and then decrease again. Particularly advantageous results can be achieved if the angular spacings become larger and smaller according to a harmonic function, e.g. the sine function. In a second embodiment, shown in FIG. 3, two angular spacings α₀ and α₁ are distributed between two groups of guide vanes. A group comprising eight guide vanes 210 is arranged on the left-hand half of the diffuser, and a group comprising nine guide vanes 211 is arranged on the right-hand half.

In both embodiments, the guide vanes are aligned in such a way that the narrowest cross-sectional area T, which in each case extends over the vane height in the diffuser channel between two guide vanes arranged adjacent to one another, is constant. This is achieved by virtue of the fact that the guide vanes are aligned differently, i.e. have different angular positions β₀, β₁, β₂, β₃ relative to the line tangential to the leading edge. Depending on the relative slope between two adjacently arranged vanes, the position of the narrowest cross-sectional area T shifts along the vane surface. On the pressure side, the narrowest cross-sectional area T here intersects the corresponding guide vane in each case in the region of the vane leading edge, while on the suction side, the line of intersection of the narrowest cross-sectional area with the respective guide vane can sometimes shift right to the end of the guide vane. In the embodiment shown in FIG. 3, the respective relative slope between two guide vanes of one group is relatively constant owing to the constant angular spacing, i.e. the respective relative angular position is approximately constant. However, differing angular positions are obtained in the region of transition between the two groups.

Further embodiments that are not shown are likewise possible. For example, all the angular spacings of the guide vanes apart from one or a few can be identical. More than two groups, each with identical angular spacings, can be formed. These pairs of guide vanes having identical angular spacings can be arranged in a row or separately from one another. As an option, the individual guide vanes of the diffuser can differ from one another in shape, length, entry and exit angle, and entry and exit radius in order to introduce additional non-uniformities into the diffuser. Here, the different design can be both in the axial direction (relative to the compressor axis), i.e. in the direction of the vane height, and in the circumferential direction. At the same time, it is possible for all or just a few of the guide vanes to be shaped or arranged differently. Such diffusers of irregular design can be constructed in a single- or multi-stage form, wherein, in the case of a plurality of stages, these can be arranged in series in the radial direction, i.e. concentrically with respect to the compressor axis. According to the present disclosure, the narrowest cross-sectional area in the diffuser channel between two guide vanes and over the diffuser channel height is constant in all these embodiments. If the diffuser has a variable i.e. non-constant diffuser channel height, over the circumference, then, according to the present disclosure, the guide vanes should be arranged in such a way that the narrowest cross-sectional area calculated in each case from the spacing of the adjacent guide vanes and the diffuser channel height is constant.

As an option, the diffuser of irregular design in the circumferential direction can be positioned in a fixed angular position with respect to the spiral casing of asymmetrical design in the circumferential direction. This enables the size of the different angular spacings and the distribution thereof along the circumference to be matched with the spiral casing of asymmetrical design downstream of the guide vanes. The angular spacings can increase similarly to the radius of the spiral casing along the circumference, for example. Or the guide vane pair which is arranged in the region of the start of the spiral tongue can have an angular spacing different from the remaining guide vane pairs.

Since the spiral casing 31 can generally be positioned in different angular positions relative to the bearing housing along the circumference, positioning means are used according to the present disclosure to ensure that the diffuser is in each case situated in the envisaged angular position relative to the spiral casing. Here, the angular position envisaged is advantageously the one at which minimal resonant vibration is produced during operation. This angular position of the diffuser relative to the spiral casing with minimal resonant vibration generation can be either calculated or determined experimentally. A possible positioning means is indicated in FIG. 2, having a positioning dog 23 on the radially outer rim of the diffuser wall 22, which engages in a positioning groove 33 in the spiral casing. Other positive positioning means are conceivable, e.g. a positioning pin, which is arranged in holes introduced on both sides. Indirect positioning by way of the third component, e.g. the inlet casing 32 or the bearing housing 30, is also conceivable.

While certain illustrative embodiments have been described in detail in the figures and the foregoing description, such an illustration and description is to be considered as exemplary and not restrictive in character, it being understood that only illustrative embodiments have been shown and described and that all changes and modifications that come within the spirit of the disclosure are desired to be protected. There are a plurality of advantages of the present disclosure arising from the various features of the methods, systems, and articles described herein. It will be noted that alternative embodiments of the methods, systems, and articles of the present disclosure may not include all of the features described yet still benefit from at least some of the advantages of such features. Those of ordinary skill in the art may readily devise their own implementations of the methods, systems, and articles that incorporate one or more of the features of the present disclosure.

1. A vaned diffuser of a radial compressor comprising:
a plurality of guide vanes distributed in a circumferential direction, wherein a first angular spacing of two guide vanes of the plurality of guide vanes arranged adjacent to one another differs from a second angular spacing of two other guide vanes of the plurality of guide vanes arranged adjacent to one another, the second angular spacing being different from the first angular spacing,
wherein at least some of the plurality of guide vanes have angular positions that differ from one another such that a narrowest cross-sectional area of each diffuser channel bounded by any two guide vanes of the plurality of guide vanes arranged adjacent to one another is the same size.

2. The vaned diffuser of a radial compressor of claim 1, wherein a plurality of pairs of guide vanes that are each arranged adjacent to one another has a different angular spacing from the remaining guide vanes that are each arranged adjacent to one another.

3. The vaned diffuser of a radial compressor of claim 2, wherein at least two pairs of guide vanes that are each arranged adjacent to one another have the first angular spacing and at least two other pairs of guide vanes that are each arranged adjacent to one another have the second angular spacing.

4. The vaned diffuser of a radial compressor of claim 3, wherein each of a plurality of pairs of guide vanes that are each arranged adjacent to one another has the same angular spacing.

5. The vaned diffuser of a radial compressor of claim 4, wherein the guide vanes are divided into a plurality of groups, each group having the same angular spacings between the guide vanes of that group that are arranged adjacent to one another.

6. The vaned diffuser of a radial compressor of claim 5, wherein the guide vanes are divided into two groups, one of the groups having one more guide vane than the other group, both groups of guide vanes being each arranged in a manner distributed over half of the circumference.

7. The vaned diffuser of a radial compressor of claim 2, wherein each pair of guide vanes that are arranged adjacent to one another has a different angular spacing from the remaining guide vanes that are each arranged adjacent to one another.

8. An exhaust turbocharger comprising:
a radial compressor having an outflow region comprising:
a spiral casing, which is of asymmetrical design in a circumferential direction and can be positioned in different angular positions in the circumferential direction, and
a vaned diffuser comprising a plurality of guide vanes distributed in the circumferential direction, wherein a first angular spacing of two guide vanes of the plurality of guide vanes arranged adjacent to one another differs from a second angular spacing of two other guide vanes of the plurality of guide vanes arranged adjacent to one another, the second angular spacing being different from the first angular spacing,
wherein at least some of the plurality of guide vanes have angular positions that differ from one another such that a narrowest cross-sectional area of each diffuser channel bounded by any two guide vanes of the plurality of guide vanes arranged adjacent to one another is the same size.

9. The exhaust turbocharger of claim 8, wherein a plurality of pairs of guide vanes that are each arranged adjacent to one another has a different angular spacing from the remaining guide vanes that are each arranged adjacent to one another.

10. The exhaust turbocharger of claim 9, wherein at least two pairs of guide vanes that are each arranged adjacent to one another have the first angular spacing and at least two other pairs of guide vanes that are each arranged adjacent to one another have the second angular spacing.

11. The exhaust turbocharger of claim 10, wherein each of a plurality of pairs of guide vanes that are each arranged adjacent to one another has the same angular spacing.

12. The exhaust turbocharger of claim 11, wherein the guide vanes are divided into a plurality of groups, each group having the same angular spacings between the guide vanes of that group that are arranged adjacent to one another.

13. The exhaust turbocharger of claim 12, wherein the guide vanes are divided into two groups, one of the groups having one more guide vane than the other group, both groups of guide vanes being each arranged in a manner distributed over half of the circumference.

14. The exhaust turbocharger of claim 9, wherein each pair of guide vanes that are arranged adjacent to one another has a different angular spacing from the remaining guide vanes that are each arranged adjacent to one another.

15. The exhaust turbocharger of claim 8, further comprising positioning means provided on the spiral casing and on the vaned diffuser for defined angular positioning of the vaned diffuser relative to the spiral casing.
